(19) United States
(12) Patent Application Publication
(10) Pub. No.: US 2014/0301766 A1
(43) Pub. Date: Oct. 9, 2014

(54) Connection Console For Mounting A Device Case On A Support Arm System

(71) Applicant: Rittal GmbH & Co. KG, Herborn (DE)

(72) Inventors: Stefan Koerner, Eschenburg (DE); Markus Neuhof, Ehringshausen (DE)

(21) Appl. No.: 14/222,730

(22) Filed: Mar. 24, 2014

(30) Foreign Application Priority Data
Apr. 5, 2013 (DE) 102013103438.1

(51) Int. Cl. F16M 13/02

(52) U.S. Cl. CPC F16M 13/02
USPC 403/4

(57) ABSTRACT

A connection console mounts a device case on a support arm system, and includes a case mounting (1) having a mounting side (2) through which the case mounting (1) can be fixed on a case in two positions which are offset by 180°. The mounting side (2) has a plurality of key hole openings (3), at least two of them being positioned offset from one another by 180°, a central part (4) which can be fixed on the case mounting (1) and which defines a usable cable space (5), and a cover element (6) which closes, as needed, a mounting and inspection opening (7) of the central part (4) through which the usable cable space (5) can be accessed.

### BACKGROUND OF THE INVENTION

The invention relates to a connection console for mounting a device case on a support arm system.

A connection console of this type is known from DE 201 11 382 U1. It comprises a mounting side through which the connection console can be fixed on a case with the aid of key hole shaped recesses. The connection console encloses a usable cable space which includes a cable catch elbow used for cable management. That connection console has the disadvantage that it must be preassembled either on the case or on the support arm system for connecting the case to the support arm system, so that a sometimes heavy and bulky case must be precisely positioned on the support arm system and screwed there to. Generally, at least two persons are needed to do that.

DE 100 13 283 B4 discloses a support aim system, wherein a support arm is fixed to a receiving case via a connection console, where the receiving case may for example be designed to receive a monitor, such as a TFT-display. A defined usable cable space can be accessed via a rear side inspection opening of the connection console which is closed by a cover element to thread connection cables from the device received within the receiving case through the receiving case and the usable cable space of the connection console into a support arm of the support arm system or to make an electrical contact between corresponding by guided cables. The support arm system has the disadvantage that, in particular due to the receiving housing, it is elaborate and thus expensive in production. In order to fasten the receiving case on the support arm, it is again mandatory that corresponding fastening openings are aligned between the receiving case and the connection console, so that fastening elements, such as screws, can be introduced. As a result, as already described with reference to DE 201 11 382 U1, increased installation costs are incurred.

### SUMMARY OF THE INVENTION

It the object of the invention, to provide a connection console of the generic type which allows simple installation of a device case on a support arm system.

According to the invention, this object is solved by a connection console having the features of claim 1. The depended claims relate to respective advantageous embodiments of the invention.

The connection console according to the invention comprises a case mounting having a mounting side through which the case mounting can be fixed on a case in two positions which are offset by 180°, wherein the mounting side has a plurality of key hole openings, at least two of them being positioned offset from one another by 180°. The connection console further comprises a central part which can be fixed on the case mounting and which defines a usable cable space. Finally, the connection console comprises a cover element which closes, as needed, a mounting and inspection opening of the central part through which the usable cable space can be accessed. The case mounting, the central part and the cover element are embodied as individual components, wherein in one embodiment, the cover element is hinged to the central part.

The connection console according to the invention is thus characterized by its three section design. The case mounting is embodied such that it, at will of the assembly man, can be fixed to the housing in two positions which are offset by 180°, so that the man does not need to take particular care in which of the both functional by identical orientations the case mounting is mounted on the case. Corresponding to both possible fixing positions on the case, the case mounting is symmetrically designed, so that always a functionally identical mounting side of the case mounting is provided for the central part to be fixed on the case mounting. This symmetry relates in particular to the mounting profiles facing the central part as well as the fixing means in particular threaded bodies which are provided for fastening the central part on the case mounting.

The mating sides of central part and case mounting via which the mentioned components adjoin each other can be adjusted such that simple and precise positioning of the components one above the other may be achieved. For example, central part and case mounting may comprise engaging slide contours via which the central part can be precisely brought into its mounting position on the case mounting, so that corresponding bores for introducing fastening screws are aligned.

In one embodiment four key hole openings corresponding to the VESA standard are arranged, i.e. either in a hole spacing of 75 mm or in a hole spacing of 100 mm. In one embodiment of the invention, it may be provided that the case mounting comprises four key hole openings in the corners of a square, wherein two first ones of the four key hole openings are equally aligned and are offset with respect to two second ones of the four key holes. In order to enable simple connection console on the device case side, it is provided in one embodiment of the invention that the case mounting comprises a continuous frame which extends from the mounting side in one direction and which defines, together with the mounting side, an installation space. In particular, it is preferred that a bar is formed on an inner surface on the continuous frame, which bas comprises a flat surface for a mounting plate or the like, wherein at least one fixing means, preferably a threaded body, is formed on the inner surface of the continuous frame or on the bas.

In order to be able to use the connection console for example simultaneously for fastening according to the VESA standard with a hole spacing of 75 mm and, as needed, for fastening according to the VESA standard with a hole spacing of 100 mm, it is provided in an embodiment of the invention that the key hole openings are formed in a peripheral zone of a cable bushing through the mounting side, wherein U-shaped fastening seats are formed adjacent to the key hole openings which are open towards the cable bushing. For example, the key hole openings may comprise a hole spacing of 100 mm, while the U-shaped fastening seats comprise a hole spacing of 75 mm.

In order to enable introduction of cables immediately into the central part, it is provided in one embodiment of the invention that a U-shaped recess is formed in at least one of the side walls defining a usable cable space which is open towards the mounting and inspection opening of the central part, wherein a cable bushing element is introduced into the U-shaped recess and wherein the cover element closes an open side of the U-shaped recess when the cover element it placed on the central part. For example, the cable bushing elements may be formed as elastic rubber elements which are slid via a guiding groove at the rim onto the borders of the U-shaped recess in a side wall of the central part. The cable bushing elements may for example comprise pre-bores of different diameter corresponding to expected cable thicknesses, wherein the pre-bores are merely closed by a thin partition wall which may easily be punched by the assembly man during mounting in order to introduce a cable of a corresponding thickness into the usable cable space.

### BRIEF DESCRIPTION OF THE DRAWINGS

Further details of the invention are explained by means of the figures below. It is shown in:

FIG. 1 a perspective front view of an embodiment of the connection console according to the invention;

FIG. 2 a perspective review of the embodiment of FIG. 1;

FIG. 3 an exploded view of the embodiment shown in FIGS. 1 and 2;

FIG. 4 a perspective view of the mounting side of the case mounting according to FIGS. 1 to 3;

FIG. 5 a perspective view of the rear side of the case mounting according to FIG. 4;

FIG. 6 a perspective view of the front side of the central part according to FIGS. 1 to 3;

FIG. 7 a perspective view of the rear side of the central part of FIG. 6;

FIG. 8 a perspective view of the front side of the cover element according to FIGS. 1 to 3;

FIG. 9 a perspective view of the rear side of the cover element of FIG. 8;

FIG. 10 a perspective view of an embodiment of the cable bushing element according to the invention;

FIG. 11 a cross sectional view of the cable bushing element illustrated in FIG. 10

### DETAILED DESCRIPTON OF THE INVENTION

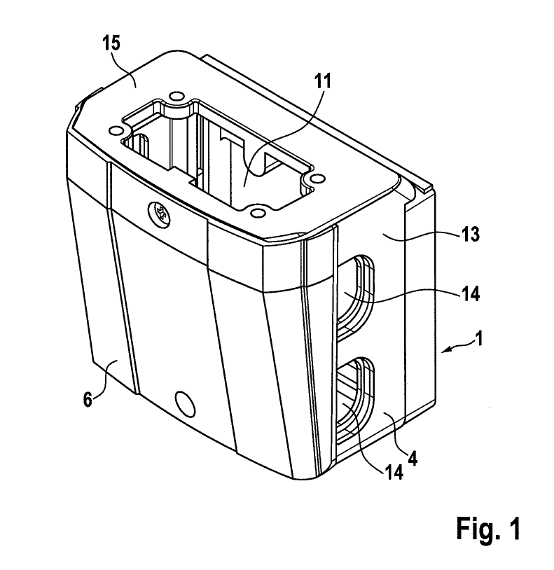

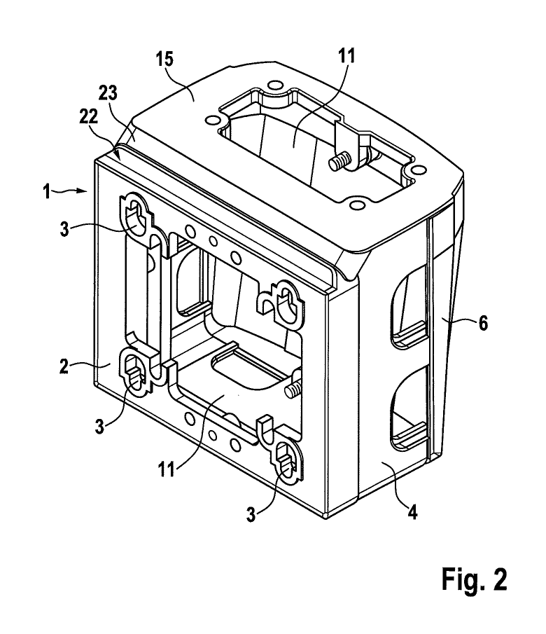

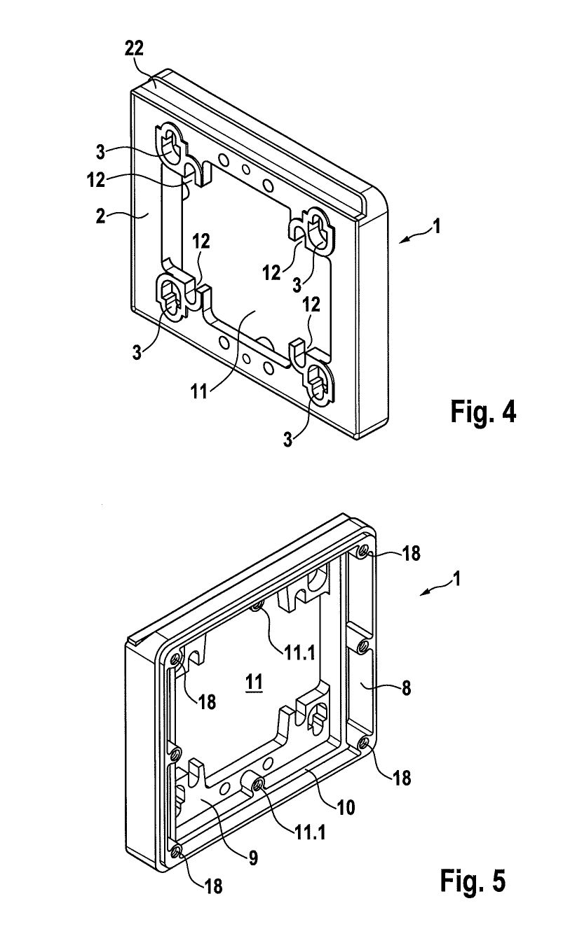

FIGS. 1 and 2 illustrate the connection console of the invention according to a first embodiment in an assembled state. The connection console has a three section design and comprises a case mounting 1, a central part 4 and a cover element 6. A mounting side 2 is formed on a side of case mounting 1 which faces, in an assembled state of the connection console, the device case. It defines a mating side having fastening means for faun fit fixing case mounting 1 and the device case. Four key hole openings 3 are provided which are arranged in the corners of a square, according to the VESA standard with a hole spacing of 100 mm. Details relating thereto will be described below with reference to FIG. 4.

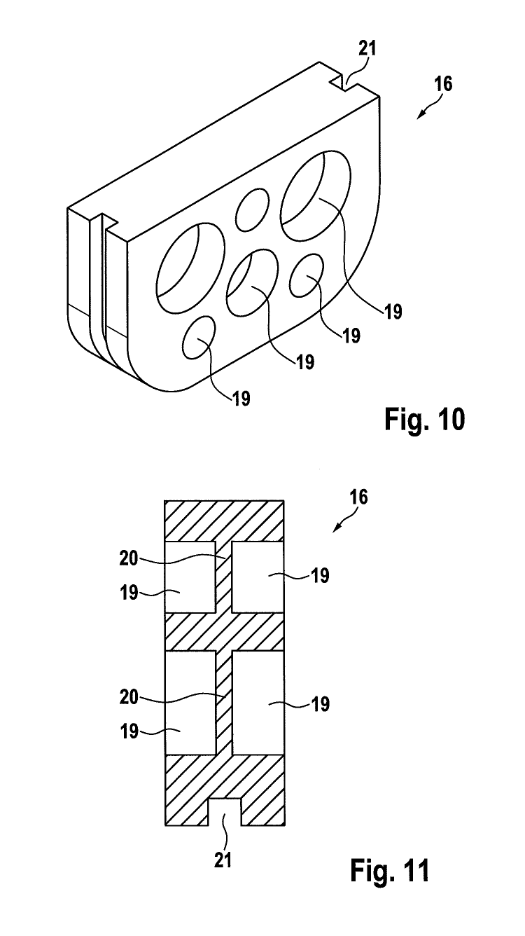

Central part 4 comprises an attachment surface 15 for mounting the connection console to a support arm system. Attachment surface 15 in turn comprises a cable bushing 16 merging into the usable cable space 5 (which is not illustrated in FIGS. 1 and 2). It is now possible to move connecting cables or the like from the support arm system into the usable cable space or vice versa. The mounting side 2 also comprises a cable bushing 11 to move cable connections and the like immediately from the device case into the usable cable space without the need of guiding such cables outside the support front system. U-shaped recesses 14 are formed in side walls 13 of central part 4 to receive cable bushing elements 16 (see FIGS. 10 and 11). In an assembled state according to FIGS. 1 and 2, cover element 6 closes an open side of U-shaped recesses 14 through which the cable bushing elements 16, when central part 6 is disassembled, may be inserted into recesses 14, so that, when cover element 6 is mounted, cable bushing elements 16 are securely held within recesses 14.

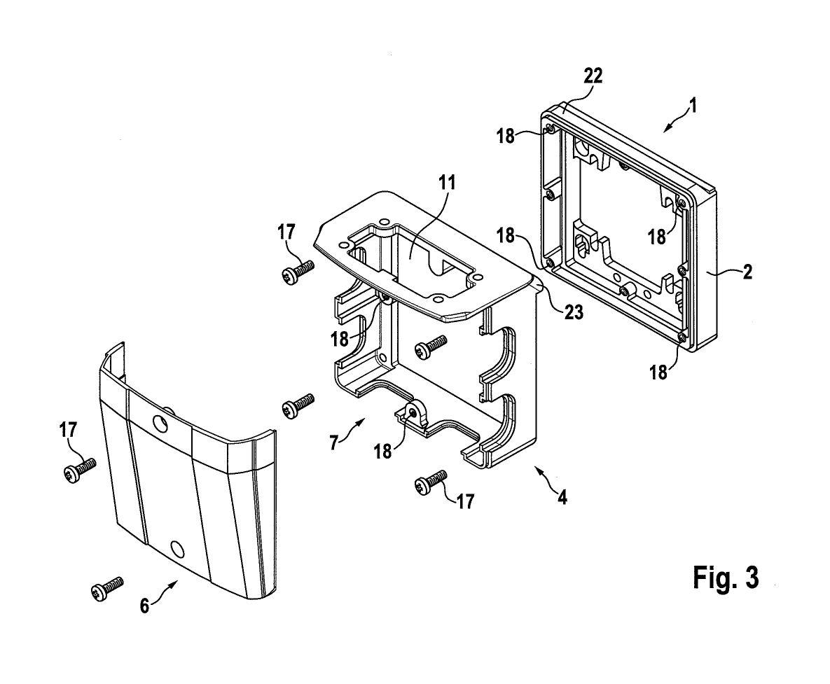

FIG. 3 illustrates the three section design of the connection console according to the invention, wherein a threaded seat 18 is formed in case mounting 1 which is substantially a rectangular component, in each corner of a side of the case mounting 1 which faces central part 4. When threaded seats 18 are aligned with respective openings of central part 4 on the side facing case mounting 1, central part 4 can be screwed to case mounting 1 by means of screws 17.

For fixing the device case on a support arm system, in a first step, case mounting 1 is screwed through key hole openings 3 in one of two positions which are rotated by 180° to a device case, as desired by the assembly man. As may be best recognized in a combined view of FIGS. 1 to 3, central part 4, which is preassembled via attachment side 15 to the support arm system, can be arranged with the aid of a tapered contour 22 formed at the case mounting 1 and the guiding edge 23 formed on central part 4, be positioned such with reference to the case mounting 1 that openings for screws 17 in central part 4 as previously described are aligned with thread seats 18 of the case mounting 1. After having pre-positioned central part 4 with respect to case mounting 1 as previously described, it may be screwed to case mounting 1 with the aid of screws 17, in order to establish a form-fit connection between devise case and support arm system. In a subsequent step, cable management can be made by accessing the usable cable space 5, when cover element 6 is disassembled, for example to make electrical connections between the support arm system and the devise case. Having made the electrical connections, the usable cable space 15 can be closed by means of cover element 6, so that case mounting 1, central part 4 and cover element 6 form a unity.

Case mounting 1 of FIGS. 1 to 3 is illustrated in detail in FIGS. 4 and 5. Mounting side 2 is flat on the side of case mounting 1 facing, in an assembled state, the devise case, in order to guarantee optimum abutment of case housing 1 on the devise case. Mounting side 2 comprises a cable bushing 11 having the key hole openings 3 in the corners of a square with side length of 100 mm in a peripheral zone. Two horizontally spaced key hole openings 3 are respectively equally aligned, two vertically spaced key hole openings 3 are arranged rotated by 180° with respect to another. So it is achieved that case mounting 1 can be fixed on device case in two positions rotated by 180°. Immediately adjacent to key hole openings 3, U-shaped fixing recesses are formed which are open towards cable bushing 11. U-shaped cable bushings 11 are formed in the corners of a square having a side length of 75 mm. Key hole openings 3 and U-shaped fastening seats 12 are arranged according to the VESA standard.

It can be recognized from FIG. 5 that frame 8 of case mounting 1 extends from mounting side 2 in one direction, so that an installation space 9 is defined by mounting side 2 in connection with frame 8. A continuous bar 10 is formed at an inner surface of frame 8, where threaded seats 11.1 are formed on the bar. Bar 10 forms a flat mating surface for a mounting plate and the like, so that installation space 9 formed by case mounting 1 may be used for connecting electrical cables which are moved from the device case and into installation space 9. For example, electrical connection elements may be provided on the mounting plate.

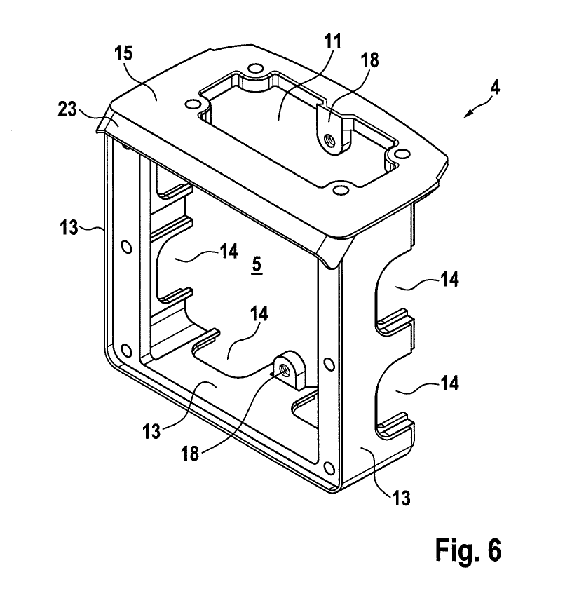

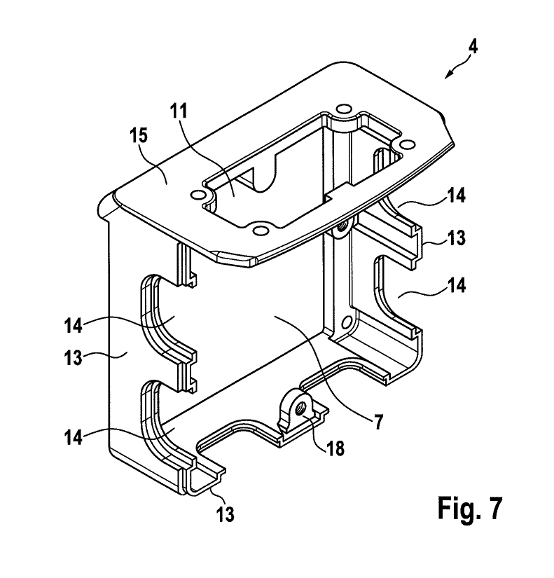

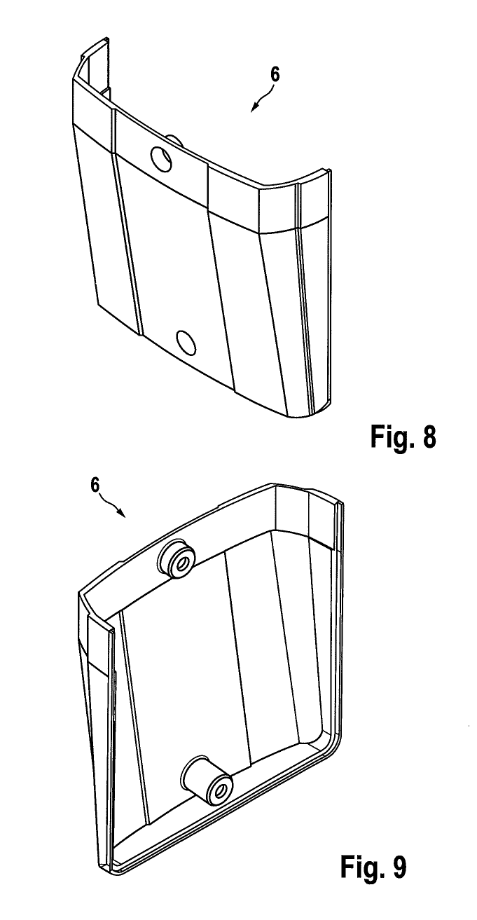

In FIGS. 6 and 7, central part 4 is illustrated in detail. Central part 4 comprises an attachment side 15 which serves to fix the connection console to a support arm system. A cable bushing 11 comprises in a peripheral zone four bores for receiving screws or similar fixing elements. For attachment of cover element 6 (see FIGS. 8 and 9) a first threaded seat 18 is formed on the attachment side 15 and on a side wall 13 opposite attachment side 15, where a second threaded seat 18 is formed. Further to attachment side 15, central part 4 comprises three more side walls 13 which, together with the attachment side 15, define the usable cable space 5. Side walls 13 comprise U-shaped recesses for receiving cable bushing elements, wherein the recesses 14 are open towards an inspection opening 7 through which the usable cable space 5 can be accessed in a completed state of the connection console after disassembling cover element 6. A guiding edge 23 is formed on the side of central part 4 facing in a mounting position case mounting 1, the guiding edge interacting with a tapered contour 22 of case mounting 1 (see FIG. 4) such that when positioning central part 4 on case mounting 1, the central part is guided into its mounting position with respect of case mounting 1.

Cover element 6 is illustrated in FIGS. 8 and 9. It is essentially wedged-shaped and convex and comprises two bores for introducing screws 17 (see FIG. 3) in order to fasten cover element 6 to central part 4 through threaded seats 18 of central part 4 (see FIG. 3). Cover element 6 comprises a sealing element at its peripheral zone.

FIGS. 10 and 11 show an embodiment of cable bushing element 16 according to the invention. It is a substantially U-shaped rubber elastic element which comprises pre-bores 19 in two parallel spaced outer sides which correspond to another, i.e. are aligned, which are only separated by a comparably thin partition wall 20. The pre-bores are formed corresponding to expected cable diameters with different diameter. In use, the assembly man can then separate the partition wall between aligned pre-bores 19 according to the real diameter of the cable to be introduced, in order to introduce the cable into the usable cable space. In order to allow simple and safe introduction of the cable bushing element 16 into the U-shaped recesses 14 of the central part (see FIGS. 6 an 7), the cable bushing element comprises a guiding groove 21 into which, in an introduced state, a corresponding spring at the periphery of the U-shaped sections 14 engages. In an inserted state and with mounted cover element 6, cover element 6 closes the insertion opening of U-shaped section 14, so that the introduced cable bushing element 16 is safely held.

The features disclosed in the foregoing description, in the claims and/or in the accompanying drawings may, both separately and in any combination thereof, be material for realising the invention in diverse forms thereof.

### REFERENCE NUMERAL LIST

1 Case mounting
2 Mounting side
3 Key hole opening
4 Central part
5 Usable cable space
6 Cover element
7 Inspection opening
8 Frame
9 Installation space
10 Bar
11 Cable bushing
11.1 Threaded body
12 Fastening seat
13 Side wall
14 U-shaped recess
15 Attachment side for a support arm system
16 Cable bushing element
17 Screw
18 Threaded seat
19 Pre-bore
20 Partition wall
21 Guiding groove
22 Tapered contour
23 Guiding edge

What is claimed is:

1. A connection console for mounting a device case on a support arm system which comprises:
a case mounting having a mounting side through which the case mounting can be fixed on a case in two positions which are offset by 180°, wherein the mounting side has a plurality of key hole openings, at least two of them being positioned offset from one another by 180°;
a central part which can be fixed on the case mounting and which defines a usable cable space; and
a cover element which closes, as needed, a mounting and inspection opening of the central part through which the usable cable space can be accessed.

2. The connection console of claim 1, wherein the case mounting comprises four key hole openings in the corners of a square, wherein two first ones of the four key hole openings are equally aligned and are offset by 180° with respect to two second ones of the four key hole openings.

3. The connection console of claim 1, wherein the case mounting comprises a continuous frame which extends from the mounting side in one direction and which defines, together with the mounting side, an installation space.

4. The connection console of claim 2, wherein the case mounting comprises a continuous frame which extends from the mounting side in one direction and which defines, together with the mounting side, an installation space.

5. The connection console of claim 3, wherein a bar is formed on an inner surface of the continuous frame within the installation space, which bar comprises a flat surface for a mounting plate or the like, wherein at least one fixing means is formed on the inner surface of the continuous frame or on the bar.

6. The connection console of claim 3, wherein a bar is formed on an inner surface of the continuous frame within the installation space, which bar comprises a flat surface for a mounting plate or the like, wherein at least one fixing means comprised of a threaded body is formed on the inner surface of the continuous frame or on the bar.

7. The connection console of claim 1, wherein the key hole openings are formed in a peripheral zone of a cable bushing through the mounting side, wherein U-shaped fastening seats are formed adjacent to the key hole openings which are open towards the cable bushing.

8. The connection console of claim 1, wherein a U-shaped recess is provided in at least one of the side walls defining the usable cable space, which recess is open towards the mounting and inspection opening of the central part, wherein a cable bushing element is inserted into the U-shaped recess and wherein the cover element closes an open side of the U-shaped recess when the cover element is placed on the central part.
